(19) United States
(12) Patent Application Publication
(10) Pub. No.: US 2024/0003061 A1
(43) Pub. Date: Jan. 4, 2024

(54) MOWING THREAD

(71) Applicant: Fabian HUBSCHMID, Eschenback (CH)

(72) Inventor: Fabian HUBSCHMID, Eschenback (CH)

(21) Appl. No.: 18/213,457

(22) Filed: Jun. 23, 2023

(30) Foreign Application Priority Data
Jun. 30, 2022 (EP) 22182149.9

(51) Int. Cl. D01F 8/02; A01D 34/416; D01F 8/14

(52) U.S. Cl. CPC D01F 8/02; A01D 34/416; D01F 8/14; D10B 2201/01; D10B 2331/041; D10B 2401/063; D10B 2401/062

(57) ABSTRACT

A mowing thread comprises a core comprising a bast fiber or a bio-degradable chemical fiber, and a shell around the core comprising a bio-degradable synthetic material.

### CROSS REFERENCE TO RELATED APPLICATIONS

This application claims the priority of European application EP22182149.9, filed Jun. 30, 2022, the disclosure of which is incorporated herein by reference in its entirety.

### FIELD OF THE INVENTION

The invention relates to a mowing thread, a string trimmer, and a method for manufacturing a mowing thread.

### BACKGROUND OF THE INVENTION

String trimmers are devices operated by a motor for trimming grass or other plants. In doing so, a trimmer head is operated by an electric motor or by a combustion engine and is triggered into rotation. A trimming tool connected with the trimmer head rotates as a result with high rotational speed and trims grass absent a counter blade or absent a counter bearing. The trimming tool may be a cutting disc or a knife shaped differently, or a thread or string supported by a thread head.

Typically, such thread is made from nylon. A nylon thread is of low brittleness and a not too high flexibility, both ideal for mowing. However, nylon is a synthetic fiber and is not bio-degradable. On the other hand, nylon threads may crack or fragment. It can be assumed that pieces of such cracked nylon threads remain in nature/on the lawn since they are not easily discoverable or are not picked up and disposed of.

### BRIEF SUMMARY OF THE INVENTION

Hence, it is a general object of the invention to provide a bio-degradable mowing thread which may remain in nature after a possible separation from the thread head and decompose there.

Now, in order to implement these and still further objects of the invention, which will become more readily apparent as the description proceeds, the mowing thread is manifested by the features of claim 1.

The mowing thread comprises a core which core comprises a bast fiber or a bio-degradable chemical fiber. The mowing thread further comprises a shell around the core, which shell comprises a bio-degradable synthetic material.

Typically, bast fibers are composite fibers from bast of a plant, and, hence, are assigned to the category of natural fibers. Bast is considered the living tissue underneath the bark of trees or other plants.

Preferably, the bast fiber used for the core is a hemp fiber. In another embodiment, the bast fiber used for the core is a flax fiber.

In the context of fibers, the usage of the singular term “fiber”, of course, encompasses multiple “fibers”, too: The manufacturing from a bast fiber or the bast fiber as such also encompasses the manufacturing from bast fiber material and, hence, as a result a core manufactured from and/or consisting of and/or comprising a multitude of bast fibers. The same is true for the bio-degradable chemical fiber.

Preferably, the individual fibers are twisted or interwoven or interlaced with/into a further fiber or other components of the core.

In another embodiment of the invention, the fiber used for the core is not a natural fiber but a bio-degradable chemical.

Chemical fibers are synthetic fibers manufactured synthetically by means of a chemical-technical procedure and are preferably made from polymers. Presently, synthetic fibers used for the core are preferably fibers made from natural polymers, preferably fibers made from regenerated cellulose. Preferably, the core comprises Lyocell fibers. Lyocell (CLY) is distributed under the trade name TENCEL™ from Lenzig AG, which product may also presently be used. In a preferred embodiment, Lyocell is used with 1.3 dtex, +/−10%.

Lyocell is a bio-degradable fiber. A bio-degradable chemical fiber or a bio-degradable synthetic material is a fiber or a synthetic material to be degraded by microorganisms with the aid of enzymes within a given period in time. The bio-degradability of Lyocell is indicated between 75% within sixty days and 100% within sixteen weeks.

Basically, a mowing thread should not be too brittle on the one hand, and not too flexible on the other hand. Brittleness represents the fracture property as a characteristic of a material. The more brittle a material is the easier it fractures, only with little previous plastic deformation. Brittle materials, hence, are typically materials with little ductility. In contrast, flexible materials are typically materials with high ductility, i.e. these materials can absorb a high amount of deformation energy prior to fracture. In the context of mowing, the pure usage of bast fibers or bio-degradable chemical fibers such as the preferred Lyocell is not possible since these fibers are too soft and, hence, too flexible for this application. They would achieve no or only little trimming effect.

Bio-degradable bast fibers or synthetic fibers do not fulfil the requirements of sufficient stiffness for a mowing thread if used stand alone as mowing thread. A further disadvantage of the high flexibility of these fibers is that the fiber structure easily bursts at high rotational speeds in view of the high centrifugal forces involved and the application of force from the mown crop acting on the mowing thread. As a result the twisted, interwoven or interlaced fibers fray.

Accordingly, a shell is provided for the core, which shell preferably completely surrounds the core radially, and preferably surrounds the core in contact with the core, and preferably is microscopically interlocked with the core. The shell comprises a bio-degradable synthetic material, or consists of a bio-degradable synthetic material. The bio-degradable synthetic material provides for a sufficient stiffness of the mowing thread, in particular a sufficient flexural stiffness and shear stiffness. It is preferred in this context that the shell comprises a flexural stiffness and/or shear stiffness exceeding the flexural stiffness and/or shear stiffness of the bast fiber or the bio-degradable chemical fiber.

Bio-degradable synthetic fibers, if used stand alone as mowing thread, typically do not fulfil the requirements of sufficient tensile strength for a mowing thread. At the high rotational speed during mowing, such mowing thread would extend in view of the considerable centrifugal forces. Such synthetic fiber would be too brittle and, hence, easily fracture owing to the impact of force from the mowing crop onto the mowing thread.

The fiber core of the suggested combination of core and shell counteracts the mentioned problems. Bast fibers or synthetic fibers such as the above mentioned Lyocell do have a high tensile strength which dominates the tensile strength of the mowing thread in total in view of the mechanical coupling between the core and the shell. This mechanical coupling preferably is achieved by leading the synthetic material for the shell in liquid or plastic phase to the core. The synthetic material then hardens while enclosing the fiber core. In this way the synthetic shell and the fiber core are tightly mechanically interlocked such that the stiffness of the mowing thread is dominated by the stiffness of the shell, while the tensile strength of the mowing thread is dominated by the tensile strength of the core. Therefore, the present mowing thread is of sufficient tensile strength as well as sufficiently stiff.

On the other hand, a bio-degradable mowing thread is provided given that the materials of its core and its shell are individually bio-degradable, are bio-degradable in combination, and, preferably, are compostable.

In an embodiment of the present invention, the core is manufactured from a bast fiber, and hence, consists of a bast fiber.

Preferably, the core is made from hemp fibers, and hence, consists of hemp fibers. Alternatively, the core is made from flax fibers, and hence, consists of flax fibers.

Alternatively, the core preferably is manufactured from a bio-degradable chemical fiber, and hence, consists of a chemical fiber. The core may be manufactured from, and, hence, consist of one of the following bio-degradable chemical fibers: Lyocell fibers, polyactide fibers, cellulose fibers, lignin fibers, viscose fibers.

In a variant, two or more of the preceding bast or chemical fibers may be combined into a core, or into a portion of the core, to which portion of the core other portions may be added.

In an embodiment of the invention, the core comprises an additional fiber made from a bio-degradable synthetic material, in addition to the bast fiber and/or the bio-degradable chemical fiber. In case the core comprises a bio-degradable chemical fiber, the additional fiber preferably comprises a different synthetic material than the bio-degradable chemical fiber. Preferably, the bio-degradable synthetic material for the additional fiber shows a lower melting point or melting temperature than the material of the bio-degradable chemical fiber.

It is in particular preferred that the bio-degradable synthetic material for the additional fiber is the same material as used for the shell, or as is comprised in the shell. The rationale for this embodiment is that by this means the coupling between the core and the shell is strengthened, and parts of the core and part of the shell may partly melt together. In case the synthetic material used for the shell is applied to the core in a heated state, the additional fibers in the core become heated and may melt together with the shell and/or better adhere to the residual fibers of the core. By such means, the core and the shell brace, and preferably interlock, in form of a quasi-chemical reaction of core and shell. This prevents the shell releasing from the core, be it during mowing, or in response to a possible cutting of the mowing thread during manufacturing.

Preferably, the additional synthetic fiber made from bio-degradable synthetic material comprises, or consists of, polylactide (PLA). Preferably, the chemical fiber is made from Lyocell and the additional synthetic fiber is made from PLA, preferably in a ratio of 70% Lyocell and 30% PLA, and preferably in combination with a shell comprising PLA. The additional synthetic fiber may also consist of one of the materials PLA, PBS, TPS, PBAT, PHA, PHB, PCL, Lignin, preferably in combination with the same material being a part of the shell.

Hence, in this embodiment the core comprises at least a bast fiber or a chemical fiber, and an additional fiber made from synthetic material. It is preferred herein, that the additional fiber if twisted or interwoven or interlaced into/with the bast fiber or into/with the chemical fiber. Preferably, a (volume) ratio of the additional fiber and the bast fiber or the bio-degradable chemical fibre is less than or equal to 1:1, and preferably is less than or equal to 1:2. Such ratio is sufficient for a strong adhesion between the shell and the bast or chemical fibre. On the other hand, such portion of the bast or chemical fiber guarantees its predominance within the combination with regard to tensile strength.

Preferably, the shell comprises a bio-degradable polymer material, or is made from a bio-degradable polymer material, and, hence, consists of a bio-degradable polymer material. Preferably, the polymer material is a bio-degradable polymer compound consisting of multiple synthetic materials, preferably multiple bio-degradable synthetic materials.

Preferably, the material of the shell comprises bio-polymers, preferably polylactide (PLA), also known as polylactid acids. Preferably, the shell is made from bio-polymers, such as polylactide (PLA) and, hence, consists of polylactide.

Preferably, the material of the shell comprises polybutylene succinate (PBS). Preferably, the shell is made from polybutylene succinate (PBS) and, hence, consists of polybutylene succinate.

Preferably, the material of the shell comprises thermoplastic starch. Preferably, the shell is made from thermoplastic starch and, hence, consists of thermoplastic starch.

Preferably, the material of the shell comprises polybutylene adipate terephthalate (PBAT). Preferably, the shell is made from polybutylene adipate terephthalate and, hence, consists of polybutylene adipate terephthalate.

Preferably, the material of the shell comprises lignin. Preferably, the shell is made from lignin and, hence, consists of lignin.

Preferably, the material of the shell comprises polyhydroxyalkanoates (PHA). Preferably, the shell is made from polyhydroxyalkanoates and, hence, consists of polyhydroxyalkanoates.

Preferably, the material of the shell comprises polyhydroxybutyrate (PHB). Preferably, the shell is made from polyhydroxybutyrate and, hence, consists of polyhydroxybutyrate.

Preferably, the material of the shell comprises polycaprolactone (PCL). Preferably, the shell is made from polycaprolactone and, hence, consists of polycaprolactone.

Preferably, the material of the shell comprises a polymer compound, comprising at least two, preferably exactly two, of the following materials: PLA, PBS, TPS, PBAT, PHA, PHB, PCL, Lignin.

Preferably, the material of the shell comprises a polymer compound, comprising at least three, preferably exactly three, of the following materials: PLA, PBS, TPS, PBAT, PHA, PHB, PCL, lignin.

Preferably, the material of the shell comprises a polymer compound, comprising PLA and at least one, preferably exactly one, of the following materials: PBS, TPS, PBAT, PHA, PHB, PCL, lignin.

Preferably, the material of the shell comprises a polymer compound, comprising PLA and at least two, preferably exactly two, of the following materials: PBS, TPS, PBAT, PHA, PHB, PCL, lignin.

Preferably, the material of the shell comprises a polymer compound, comprising PHA and at least one, preferably exactly one, of the following materials: PBS, TPS, PBAT, PLA, PHB, PCL, lignin.

Preferably, the material of the shell comprises a polymer compound, comprising PHA and at least two, preferably exactly two, of the following materials: PBS, TPS, PBAT, PLA, PHB, PCL, lignin.

Preferably, the material of the shell comprises a polymer compound, comprising PHB and at least one, preferably exactly one, of the following materials: PBS, TPS, PBAT, PLA, PHA, PCL, lignin.

Preferably, the material of the shell comprises a polymer compound, comprising PHB and at least two, preferably exactly two, of the following materials: PBS, TPS, PBAT, PLA, PHA, PCL, lignin.

Preferably, the material of the shell comprises a polymer compound, comprising PHA, PBS and at least one, preferably exactly one, of the following materials: TPS, PBAT, PLA, PHB, PCL, lignin.

Preferably, the material of the shell comprises a polymer compound, comprising at least, preferably exactly, PLA, PBS and PBAT.

Preferably, the material of the shell comprises a polymer compound, comprising at least, preferably exactly, PHA, PBS and PCL.

In a preferred embodiment, the bio-degradable synthetic material is Bio-Flex® F 1804 from company FKUR, comprising PLA and additional bio-degradable synthetic materials.

This one or a different synthetic material to be used for the shell preferably is capable of being extruded, given that during manufacturing of the mowing thread a method of extruding is used for applying the synthetic material to the core. Insofar it is preferred that the synthetic material has a melting temperature of more than 100° C., preferably more than 150° C., such that the synthetic material can be processed in conventional extruders.

The mowing thread preferably has a diameter between 1 mm and 4 mm. A thickness of the layer of the shell preferably is between 0.2 mm and 0.4 mm, independent from the diameter of the mowing thread. It was found that such a shell layer thickness is sufficient for protecting the core and, at the same time, for providing a sufficient stiffness of the mowing thread independent from a diameter of the core of the mowing thread in a range between 0.8 mm and 3.6 mm.

According to a further aspect of the present invention, a string trimmer is provided comprising a mowing thread according to any of the previous embodiments. A string trimmer is a motor operated device for mowing grass or other plants. A mowing head is driven by means of an electric motor or a combustion engine and rotates. Presently, the mowing head preferably is a thread head at which the mowing thread, also known as mowing string, is fixed by one of its ends. Owing to the drive mowing thread rotates in high rotational speed and trims the grass absent any counter blade or counter bearing.

According to a further aspect of the present invention, a method is provided for manufacturing a mowing thread. First, a core is provided comprising at least a bast fiber or a bio-degradable chemical fiber. Preferably, the core comprises such fibres in twisted or interwoven or interlaced manner. A bio-degradable synthetic material will be heated and extruded for forming the shell. The extrudate is applied to the bast fiber or the bio-degradable chemical fiber for shaping the shell to the core. The extrudate is understood as material delivered by an extruder, from which material the shell is formed onto the core. Preferably, an extruder is used in this method, for example, a screw extruder or a ram extruder, wherein the screw or the ram serve for conveying the extrudate. The extrudable basic material, i.e. the bio-degradable synthetic material to make the shell from, is supplied into the extruder, for example in form of granulate. The extruder typically comprises a heater for heating the basic material above its melting temperature such that the liquidized or at least viscous synthetic material is supplied as extrudate to its destination by means of the conveying mechanism inherent in the extruder, such as a screw. Preferably the destination, e.g. defined by the outlet of the extruder, is a stationary location at which the core including the bast fiber or the bio-degradable chemical fiber passes by. For doing so, the core is translational passes by the stationary location, preferably at constant speed. At the stationary location at or close to the outlet of the extruder, the core gets in touch with the extrudate. Preferably, shaping means are provided for shaping the extrudate into the desired shape relative to the core. Such shaping means may, for example, include a tube which comprises an e.g. radial inlet for the extrudate at the stationary location. At this position, the extrudate flows into the interior of the tube. At one of the front ends of the tube the core is moved into the interior of the tube, and preferably through the tube, preferably along a longitudinal axis of the tube, by a conveyor. At the stationary position, the extrudate is supplied to the core passing by at constant speed. By way of the tube having e.g. a circular cross section the outer shape of the shell is determined. Different outer shapes are possible, such as square, triangle, star outer shapes, etc. The extrudate preferably is hardened after being applied onto the core. Preferably, water cooling is applied for hardening, i.e. the mowing thread is led through a bath of water. Or air cooling is applied, i.e. cool air is applied to the mowing thread by means of a blower. As a result, the shell is manufactured and is in a solid shape. Preferably, the conveyor tackles the manufactured thread for making its previously non-shelled core passing by the outlet of the extruder. The conveyor preferably comprises one or more draw rolls tackling the cooled shell and thereby unwinding the core from an unwinding roll and making it pass by the extruder or pass through the extruder, preferably at constant speed. The conveyor may comprise guiding means such as guiding rails, support rolls, etc. Preferably, a cutting tool is provided after the conveyor for cutting the mowing thread into a desired length. Alternatively, the mowing thread may be coiled onto a reel and only will later be cut into the desired length from the reel, e.g. in retail or elsewhere.

In case the core comprises an additional fiber, such as a fiber made from the same synthetic material the shell is made from, such a fiber preferably can be manufactured from extruding the corresponding synthetic material granulate. After extruding the additional fiber preferably is stretched, i.e. tensioned close before cracking. This procedure increases the tension strength of the additional fiber. The additional fiber preferably is twisted or interlaced with the other fibers contributing to the core.

The bio-degradability of synthetic materials preferably is determined according to test procedures. A test procedure according to standard EN 13432 e.g. confirms bio-degradability in case 90% of the organic material is transformed into CO2 after six months in an aqueous medium or environment. In an additional test within this standard, the capability of composting a material can be determined: A material is considered as compostable only in case only 10% or less of the original mass of the material remains after three months of composting and subsequent fine sieving. Preferably, the chemical fiber, the additional synthetic fiber of the core, and the material of the shell are bio-degradable according to this standard, preferably additionally are compostable according to this standard.

The standards EN 14995 and ASTM D6400 define similar testing procedures.

Preferably, the chemical fiber, the additional synthetic fiber of the core, and the material of the shell are bio-degradable according to at least one of the above standards EN 13432, EN 14995 and ASTM D6400, preferably according to all three standards.

### BRIEF DESCRIPTION OF THE DRAWINGS

Consideration is given to the following detailed description of embodiments of the present invention. Such description makes reference to the annexed drawings, wherein:

FIG. 1 illustrates a mowing thread according to an embodiment of the present invention;

FIG. 2 illustrates a mowing thread according to a further embodiment of the present invention; and

FIG. 3 illustrates a method for manufacturing a mowing thread, according to an embodiment of the present invention.

### DETAILED DESCRIPTION OF THE INVENTION

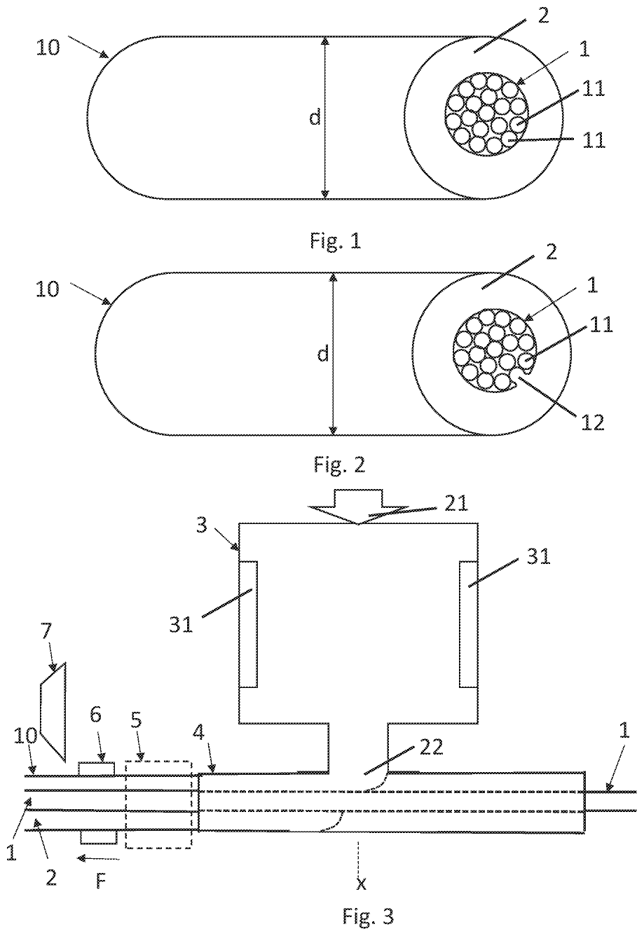

FIG. 1 illustrates a mowing thread according to an embodiment of the present invention. The mowing thread 10 comprises a core 1 and a shell 2 around the core 1. Presently, core 1 and shell 2 are of circular cross section. However, different shapes of cross sections are possible.

It is schematically indicated that the core 1 comprises a bast fiber or a bio-degradable chemical fiber 11, respectively a multitude of such fibers 11. The individual fibers may twist around each other in a helical shape or are interwoven. The number of the individual fibers 11 is not representative. Presently, the mowing thread 10 comprises a Lyocell fiber as bio-degradable chemical fiber. The shell 2 around the core 1 is made from a bio-degradable synthetic material.

FIG. 2 illustrates a mowing thread according to a further embodiment of the present invention. The mowing thread 10 of FIG. 2 differs from the mowing thread of FIG. 1 in that the core 1 comprises additional fibers 12 of the same material the shell 2 is made from. It is schematically shown, that owing to the melting of the additional fiber 12 which is based on thermal conditions while applying the shell 2 to the core 1, these additional fibers 12 melt or fuse with the shell 2, and, hence, build a unity together with the shell 2. This effect increases bonds between the shell 2 and the core 1.

FIG. 3 schematically illustrates a method for manufacturing a mowing thread, according to an embodiment of the present invention. Reference sign 3 shows an extruder, such as a screw extruder or a ram extruder, wherein a screw or a ram serve for conveying the extrudate. Other than the heating 31, details such as screw or ram are not explicitly illustrated in FIG. 3. The extruder 3 is filled with an extrudable material, presently with a bio-degradable synthetic material 21. This synthetic material 21 is heated by means of the heater 31 beyond its melting point, and is conveyed by way of a conveyor of the extruder, i.e. the screw or the ram, in its soft of liquid state as extrudate to a shaping means 4.

The shaping means 4 presently is represented by a tube which comprises an inlet for the extrudate 22 at a stationary location x. At this location x, the extrudate 22 flows into the interior of the tube. The later core of the mowing thread is supplied into the tube by means of a not illustrated conveyor. The core 1 preferably is a bast fiber or a bio-degradable chemical fiber. Its supply into the tube/into the shaping means 4 is processed constantly, e.g. from an unwinding roll provided for the bast or chemical fiber. Electric motors, rolls, guides, alone or in combination may contribute to the conveyor, in particular draw rolls such as indicated by reference sign 6. It is preferred that the mowing thread 10 is conveyed by a tensioning force in direction F. Hereby, the core 1 is unwound from the not illustrated roll and is supplied to the shaping means 4. The shaping means 4 preferably comprises guides holding the core 1 centered in the tube. The flow of the extrudate 22 is schematically indicated by way of the bows at the outlet of the extruder 3, which flow adapts within the shaping means 4 to the core 1 owing to space limitations. In view of the shape of the tube, the extrudate 22 takes a circular circumference. The extrudate 22 hardens in a subsequent cooling 5, e.g. a water cooling, and, hence, forms a solid shell 2 around the core 1, resulting in a mowing thread 10 with a core 1 and a shell 2. The mowing thread 10 manufactured and conveyed by this method can be cut into the desired length by means of a cutting tool 7, or may be coiled onto a reel and only will later be cut into the desired length from the reel, e.g. in retail or elsewhere.

While there are shown and described presently preferred embodiments of the invention, it is to be dis-tinctly understood that the invention is not limited thereto but may be otherwise variously embodied and practised within the scope of the following claims.

1. Mowing thread, comprising
a core comprising a bast fiber or a bio-degradable chemical fiber, and
a shell around the core comprising a bio-degradable synthetic material.

2. Mowing thread according to claim 1, wherein the bast fiber is a hemp fiber or a flax fiber.

3. Mowing thread according to claim 1, wherein the bio-degradable chemical fiber is a Lyocell fiber.

4. Mowing thread according to claim 1, wherein the core comprises a fiber made from a bio-degradable synthetic material in addition to the bast fiber or in addition to the bio-degradable chemical fiber.

5. Mowing thread according to claim 4, wherein the additional fiber is manufactured from a different bio-degradable synthetic material than the bio-degradable chemical fiber.

6. Mowing thread according to claim 4, wherein the additional fiber is manufactured from the bio-degradable synthetic material the shell consists of or that is comprised in the shell.

7. Mowing thread according to claim 1, wherein the shell comprises a bio-degradable polymer material.

8. Mowing thread according to claim 7, wherein the shell comprises two or more of the following materials: polylactid acid (PLA), polybutylene succinate (PBS), thermoplastic starch (TPS), polybutylene adipate terephthalate (PBAT), polyhydroxyalknaoate (PHA), polyhydroxybutyrate (PHB), polycaprolactone (PCL), and Lignin.

9. Mowing thread according to claim 1, wherein the shell comprises biopolymers, preferably polylactide.

10. Mowing thread according to claim 1, wherein the bast fiber or the bio-degradable chemical fiber has a tensile strength exceeding a tensile strength of the shell.

11. Mowing thread according to claim 1, wherein the shell has a flexural stiffness and/or a shear stiffness exceeding the flexural stiffness and/or shear stiffness of the bast fiber or the bio-degradable chemical fiber.

12. Mowing thread according to claim 1, wherein the shell is manufactured from an extrudable synthetic material.

13. Mowing thread according to claim 1, wherein the shell is manufactured from a synthetic material having a melting temperature of more than 100° C.

14. Mowing thread according to claim 1, wherein the mowing thread has a diameter between 1 mm and 4 mm.

15. String trimmer, comprising a mowing thread according to claim 1.

16. Method for manufacturing a mowing thread, comprising
providing a core, the core comprising at least a bast fiber or a bio-degradable chemical fiber,
heating and extruding a bio-degradable synthetic material, and
supplying the extrudate to the core for shaping a shell around the core.

17. Method according to claim 16, comprising
conveying the core,
supplying the extrudate to the core at a stationary position, the core passing the stationary position,
wherein shaping means effect a uniform forming of the extrudate to the core, and
wherein the shell is built by hardening the extrudate.

18. Method according to claim 16,
wherein providing the core includes twisting or interweaving or interlacing of an additional fiber made from a bio-degradable synthetic material with the bast fiber or with the bio-degradable chemical fiber.

19. Method according to claim 18,
wherein the additional fiber is manufactured from the same bio-degradable synthetic material the shell consists of or that is comprised in the shell.

20. Method according to claim 18,
wherein a ratio of the additional fiber and the portion of the bast fiber or the bio-degradable chemical fiber is less than or equal to 1:1.
